(19) United States
(12) Patent Application Publication
(10) Pub. No.: US 2011/0299205 A1
(43) Pub. Date: Dec. 8, 2011

(54) VOLTAGE PROTECTING CIRCUIT FOR ELECTRONIC DEVICE

(75) Inventor: Heng-Chen Kuo, Tu-Cheng (TW)

(73) Assignee: HON HAI PRECISION INDUSTRY CO., LTD., Tu-Cheng (TW)

(21) Appl. No.: 12/818,184

(22) Filed: Jun. 18, 2010

(30) Foreign Application Priority Data
Jun. 3, 2010 (TW) 99117974

(51) Int. Cl. H02H 3/06; H02H 3/20

(52) U.S. Cl. 361/59

(57) ABSTRACT

A voltage protecting circuit includes a switch unit, an upper limited voltage detecting unit, a lower limited voltage detecting unit, and a logic control unit. When a voltage output from a voltage input interface is less than the lower limited voltage or greater than the upper limited voltage, the logic control unit outputs a control signal to turn the switch unit off. The output voltage outputted from the voltage input interface is not provided to a working circuit. When the output voltage outputted from the voltage input interface is greater than the lower limited voltage and less than the upper limited voltage, the logic control unit outputs a control signal to turn the switch unit on. The output voltage output from the voltage input interface is provided to the working circuit.

### BACKGROUND

1. Technical Field

The present disclosure relates to voltage protecting circuits, and particularly to a voltage protecting circuit for preventing electronic devices from being damaged when power is mistakenly applied.

2. Description of Related Art

When an input voltage of an electronic device is greater or less than the rated voltage of the electronic device, the electronic device may be damaged or perform erratically. Therefore there is room for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is a block diagram of an exemplary embodiment of a voltage protecting circuit connected between a voltage input interface and a working circuit.

FIG. 2 is a circuit diagram of the voltage protecting circuit of FIG. 1.

### DETAILED DESCRIPTION

The disclosure, including the drawings is illustrated by way of example and not by limitation. It should be noted that references to “an” or “one” embodiment in this disclosure are not necessarily to the same embodiment, and such references mean at least one.

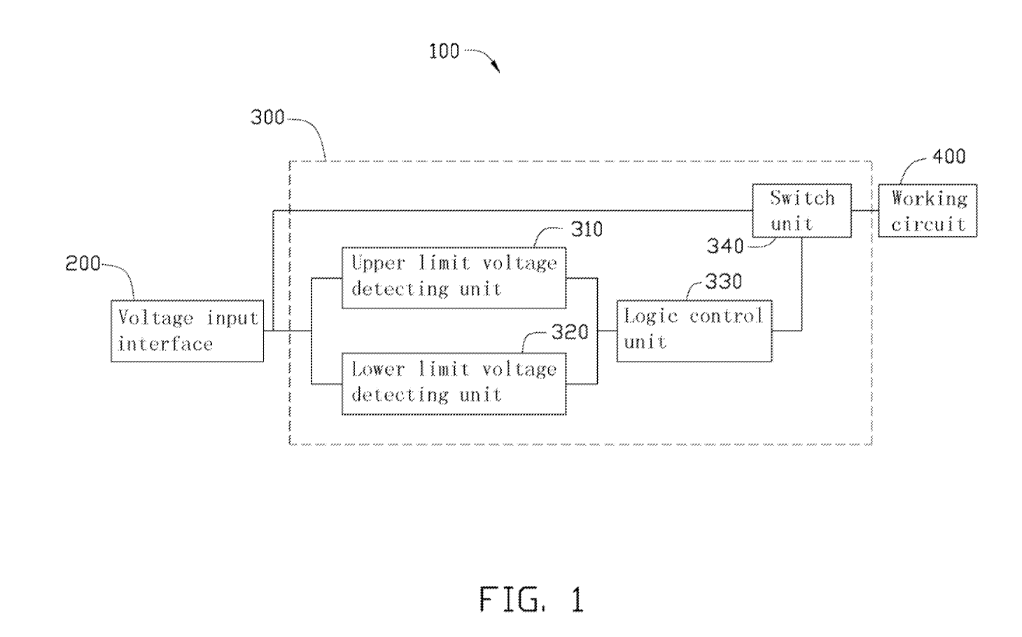

Referring to FIG. 1, an exemplary embodiment of a voltage protecting circuit 300 is arranged in an electronic device 100. The voltage protecting circuit 300 is connected between a voltage input interface 200 and a working circuit 400 of the electronic device 100 and control an output voltage of the voltage input interface 200 to not be provided to the working circuit 400 when the output voltage of the voltage input interface 200 does not conform to a rated voltage of the electronic device 100. The voltage protecting circuit 300 includes an upper limit voltage detecting unit 310, a lower limit voltage detecting unit 320, a logic control unit 330, and a switch unit 340.

The upper limit voltage detecting unit 310 and the lower limit voltage detecting unit 320 are connected between the voltage input interface 200 and the logic control unit 330. The switch unit 340 is connected to the logic control unit 330, the voltage input interface 200, and the working circuit 400. The upper limit voltage detecting unit 310 and the lower limit voltage detecting unit 320 detect the output voltage of the voltage input interface 200 and output detecting signals to the logic control unit 330. The logic control unit 330 receives the detecting signals and outputs a control signal to control the switch unit 340 to be closed or opened. When the switch unit 340 is closed, the output voltage of the voltage input interface 200 is provided to the working circuit 400 of the electronic device 100. When the switch unit 340 is opened, the output voltage of the voltage input interface 200 is not provided to the working circuit 400 of the electronic device 100. Therefore, the output voltage of the voltage input interface 200 is not provided to the working circuit 400 when the output voltage of the voltage input interface 200 does not conform to the rated voltage of the electronic device 100, to prevent the electronic device 100 from being damaged.

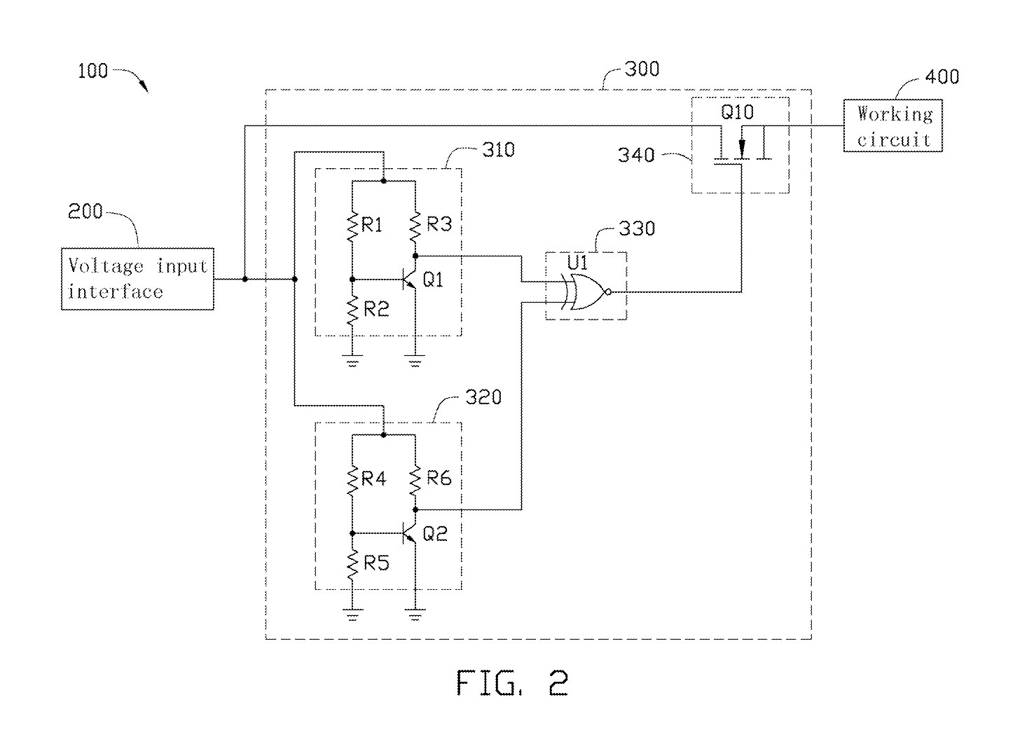

Referring to FIG. 2, the upper limit voltage detecting unit 310 includes a transistor Q1 and resistors R1-R3. An output terminal of the voltage input interface 200 is connected to a base of the transistor Q1 via the resistor R1, and also connected to a collector of the transistor Q1 via the resistor R3. The base of the transistor Q1 is grounded via the resistor R2. An emitter of the transistor Q1 is grounded. The collector of the transistor Q1 is connected to the logic control unit 330. In the embodiment, the transistor Q1 is an npn transistor. In other embodiments, the transistor Q1 can be an n-channel metal oxide semiconductor field effect transistor (NMOSFET).

The lower limit voltage detecting unit 320 includes a transistor Q2 and resistors R4-R6. The output terminal of the voltage input interface 200 is connected to a base of the transistor Q2 via the resistor R4, and also connected to a collector of the transistor Q2 via the resistor R6. The base of the transistor Q2 is grounded via the resistor R5. An emitter of the transistor Q2 is grounded. The collector of the transistor Q2 is connected to the logic control unit 330. In the embodiment, the transistor Q2 is an npn transistor. In other embodiments, the transistor Q2 can be an NMOSFET.

The logic control unit 330 includes a gate element U1. A first input terminal of the gate element U1 is connected to the collector of the transistor Q1. A second input terminal of the gate element U1 is connected to the collector of the transistor Q2. An output terminal of the gate element U1 is connected to the switch unit 340.

The switch unit 340 includes an electronic switch, such as an n-channel field effect transistor (FET) Q10. A gate of the FET Q10 is connected to the output terminal of the gate element U1. A drain of the FET Q10 is connected to the output terminal of the voltage input interface 200. A source of the FET Q10 is connected to the working circuit 400.

In one embodiment, different output voltages of the voltage input interface 200 can be detected by selecting different resistances of the resistors R1, R2, R4, and R5. Resistances of the resistors R1, R2, R4, and R5 can be selected according to an upper limit voltage Vup and a lower limit voltage Vlow of the electronic device 100. Relationships between resistor values and detected voltages are as follows:

$$\begin{matrix}\frac{Vlow}{VQ 2} = \frac{R 4 + R 5}{R 5} & ( 1 ) \\ \frac{Vup}{VQ 1} = \frac{R 1 + R 2}{R 2} & ( 2 )\end{matrix}$$

Wherein VQ2 is a turn-on voltage of the transistor Q2, VQ1 is a turn-on voltage of the transistor Q1, and the VQ1=VQ2=0.7V.

In one embodiment, the upper limit voltage Vup of the electronic device 100 is 14V, and the lower limit voltage Vlow of the electronic device 100 is 10V. If the output voltage of the voltage input interface 200 is equal to the lower limit voltage Vlow, and a dividing voltage of the resistors R4 and R5 is greater than the turn-on voltage VQ2, the resistance of the resistor R5 is preset to 1 kilohms (K u), and then the resistance of the resistor R4 is 13.2 K Ω according to the formula (1). If the output voltage of the voltage input interface 200 is equal to the upper limit voltage Vup, and a dividing voltage of the resistors R1 and R2 is greater than the turn-on voltage VQ1, the resistance of the resistor R2 is preset to 1 KΩ, and then the resistance of the resistor R1 is 19 KΩ according to the formula (2).

In use, when the output voltage (e.g., 9.9V) of the voltage input interface 200 is less than the lower limit voltage Vlow (10V) of the electronic device 100, the output voltage of the voltage input interface 200 is divided by the resistors R1 and R2. A voltage on the resistor R2 is less than the turn-on voltage VQ1 of the transistor Q1, the transistor Q1 is turned off. The collector of the transistor Q1 is at a high level (e.g., 3V) by receiving a voltage from the voltage input interface 200 via the resistor R3. The first input terminal of the gate element U1 receives a high level signal. At the same time, the output voltage of the voltage input interface 200 is divided by the resistors R4 and R5. A voltage on the resistor R5 is less than the turn-on voltage VQ2 of the transistor Q2, the transistor Q2 is turned off. The collector of the transistor Q2 is at a high level by receiving a voltage from the voltage input interface 200 via the resistor R6. The second input terminal of the gate element U1 receives a high level signal. Namely, the first and the second input terminals of the gate element U1 both receive high level signals, and the output terminal of the gate element U1 outputs a high level signal. The FET Q10 receives the high level signal and is turned off. The output voltage of the voltage input interface 200 is not provided to the working circuit 400 of the electronic device 100.

When the output voltage (e.g., 12V) of the voltage input interface 200 is greater than the lower limit voltage Vlow (10V) of the electronic device 100 and is less than the upper limit voltage Vup (14V) of the electronic device 100, the output voltage of the voltage input interface 200 is divided by the resistors R1 and R2. A voltage on the resistor R2 is less than the turn-on voltage VQ1 of the transistor Q1, the transistor Q1 is turned off. The collector of the transistor Q1 is at a high level (e.g., 3V) by receiving a voltage from the voltage input interface 200 via the resistor R3. The first input terminal of the gate element U1 receives a high level signal. At the same time, the output voltage of the voltage input interface 200 is divided by the resistors R4 and R5. A voltage on the resistor R5 is greater than the turn-on voltage VQ2 of the transistor Q2, the transistor Q2 is turned on. The collector of the transistor Q2 is at a low level. The second input terminal of the gate element U1 receives a low level signal. Namely, the first input terminal of the gate element U1 receives a high level signal and the second input terminals of the gate element U1 receives a low level signal, and the output terminal of the gate element U1 outputs a low level signal. The FET Q10 receives the low level signal and is turned on. The output voltage of the voltage input interface 200 is provided to the working circuit 400 of the electronic device 100.

When the output voltage (e.g., 14.1V) of the voltage input interface 200 is greater than the upper limit voltage Vup (14V) of the electronic device 100, the output voltage of the voltage input interface 200 is divided by the resistors R1 and R2. A voltage on the resistor R2 is greater than the turn-on voltage VQ1 of the transistor Q1, the transistor Q1 is turned on. The collector of the transistor Q1 is at a low level. The first input terminal of the gate element U1 receives a low level signal. At the same time, the output voltage of the voltage input interface 200 is divided by the resistors R4 and R5. A voltage on the resistor R5 is greater than the turn-on voltage VQ2 of the transistor Q2, the transistor Q2 is turned on. The collector of the transistor Q2 is at a low level. The second input terminal of the gate element U1 receives a low level signal. Namely, the first and the second input terminals of the gate element U1 both receive low level signals, and the output terminal of the gate element U1 outputs a high level signal. The FET Q10 receives the high level signal and is turned off. The utput voltage of the voltage input interface 200 is not provided to the working circuit 400 of the electronic device 100.

The voltage protecting circuit 300 detects the output voltage of the voltage input interface 200 and outputs a control signal to control the output voltage of the voltage input interface 200 to be provided to the working circuit 400 of the electronic device 100. Therefore, the voltage protecting circuit 300 can prevent the electronic device 100 from being damaged.

It is to be understood, however, that even though numerous characteristics and advantages of the present disclosure have been set forth in the foregoing description, together with details of the structure and function of the disclosure, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A voltage protecting circuit connected between a voltage input interface and a working circuit, the voltage protecting circuit comprising:
an upper limit voltage detecting unit connected to the voltage input interface, to detect an output voltage of the voltage input interface and outputs a first detecting signal;
a lower limit voltage detecting unit connected to the voltage input interface, to detect the output voltage of the voltage input interface and outputs a second detecting signal;
a switch unit connected between the voltage input interface and the working circuit;
a logic control unit connected to the upper limit voltage detecting unit, the lower limit voltage detecting unit, and the switch unit, wherein the logic control unit receives the first and the second detecting signals from the upper limit voltage detecting unit and the lower limit voltage detecting unit, and controls the switch unit to be closed or opened, when the output voltage of the voltage input interface is less than a lower limit voltage or is greater than an upper limit voltage, the logic control unit controls the switch unit to be opened, the output voltage of the voltage input interface is not provided to the working circuit; when the output voltage of the voltage input interface is greater than the lower limit voltage and is less than the upper limit voltage, the logic control unit controls the switch unit to close, the output voltage of the voltage input interface is provided to the working circuit.

2. The voltage protecting circuit of claim 1, wherein when the output voltage of the voltage input interface is less than the lower limit voltage, the logic control unit receives high level signals from the upper limit voltage detecting unit and the lower limit voltage detecting unit, and controls the switch unit to be opened, the output voltage of the voltage input interface is not provided to the working circuit; when the output voltage of the voltage input interface is greater than the lower limit voltage and is less than the upper limit voltage, the logic control unit receives a high level signal from the upper limit voltage detecting unit and receives a low level signal from the lower limit voltage detecting unit, and controls the switch unit to be closed, the output voltage of the voltage input interface is provided to the working circuit;
when the output voltage of the voltage input interface is greater than the upper limit voltage, the logic control unit receives low level signals from the lower limit voltage detecting unit and the upper limit voltage detecting unit, and controls the switch unit to be opened, the output voltage of the voltage input interface is not provided to the working circuit.

3. The voltage protecting circuit of claim 1, wherein the upper limit voltage detecting unit comprises a first transistor and first to third resistors, an output terminal of the voltage input interface is connected to a base of the first transistor via the first resistor and also connected to a collector of the first transistor via the third resistor, the base of the first transistor is grounded via the second resistor, an emitter of the first transistor is grounded, the collector of the first transistor is connected to the logic control unit.

4. The voltage protecting circuit of claim 3, wherein the lower limit voltage detecting unit comprises a second transistor and fourth to sixth resistors, the output terminal of the voltage input interface is connected to a base of the second transistor via the fourth resistor and also connected to a collector of the second transistor via the sixth resistor, the base of the second transistor is grounded via the fifth resistor, an emitter of the second transistor is grounded, the collector of the second transistor is connected to the logic control unit.

5. The voltage protecting circuit of claim 4, wherein the logic control unit comprises a gate element, a first input terminal of the gate element is connected to the collector of the first transistor, a second input terminal of the gate element is connected to the collector of the second transistor, an output terminal of the gate element is connected to the switch unit.

6. The voltage protecting circuit of claim 5, wherein the switch unit comprises an electronic switch, a first terminal of the electronic switch is connected to the output terminal of the gate element, a second terminal of the electronic switch is connected to the output terminal of the voltage input interface, a third terminal of the electronic switch is connected to the working circuit.

7. The voltage protecting circuit of claim 6, wherein the electronic switch is an n-channel field effect transistor (FET), and the first to third terminals of the electronic switch are a gate, a drain, and a source of the FET, respectively.
